(19) United States
(12) Patent Application Publication
(10) Pub. No.: US 2004/0160134 A1
(43) Pub. Date: Aug. 19, 2004

(54) Air-cooled generator with static excitation means

(76) Inventors: Richard Blatter, Schaffhausen (CH); Hans-Werner Schlett, Waldshut (DE); Mathias Wittwer, Zuerich (CH); Oliver Luder, Kucsnacht (CH); Peter Vogler, Zuerich (CH)

Correspondence Address: ADAM J. CERMAK, LAW OFFICE OF ADAM J. CERMAK, P.O. BOX 7518, ALEXANDRIA, VA, 22307-7518, US

(21) Appl. No.: 10/386,679

(22) Filed: Mar. 13, 2003

(30) Foreign Application Priority Data
Mar. 13, 2002 (CH) 2002 0440/02

(51) Int. Cl. H02K 9/00

(52) U.S. Cl. 310/52

(57) ABSTRACT

In an air-cooled high power generator (10) with static excitation means (19, 22, 24, 26), which static excitation means (19, 22, 24, 26) comprise a cooled rectifier bridge arrangement (26), design simplification, enhanced reliability and space savings are achieved by placing the cooled rectifier bridge arrangement (26) in a cooling air circuit (23) of said generator (10).

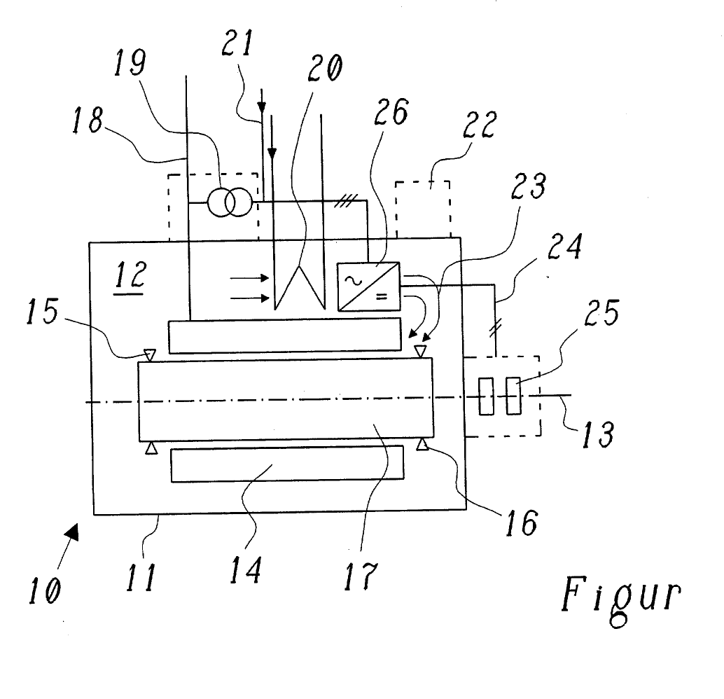

This application claims priority under 35 U.S.C. § 119 to Swiss patent application number 2002 0440/02, filed Mar. 13, 2002, the entirety of which is incorporated by reference herein.

### FIELD OF INVENTION

The present invention is applicable within the field of power generation. It relates to an air-cooled high power generator with static excitation means according to the preamble of claim 1. By high power generators is meant generators that are employed for generating power in power plants.

### PRIOR ART

In conjunction with static excitation means, it is conventional to install the control and monitoring means as well as rectifiers in cabinets in separate electronic control rooms or in the vicinity of the generator. Normally, it is necessary to cool rectifier bridges disposed in the excitation means with forced-air in order to be able to dissipate the heat lost during operation. This is generally accomplished by fans, which cool the rectifier bridge cabinets by means of forced ventilation (see for example, General Electric Company's GEI-100477 publication of June 2000 on the EX2000 Excitation System). Availability of these ventilators is such that usually an extra set of ventilators is used.

Previously, in hydrogen-cooled generators, it was proposed to place the excitation transformer aligned with the excitation means within the generator housing in the internal cooling air circuit (U.S. Pat. No. 4,477,767 or U.S. Pat. No. 3,702,965). However, the rectifier bridge arrangement was located separately outside the generator housing.

It is also known from EP-B1-0 707 732 to place frequency adaptor units (frequency converters) that are fitted with power semiconductors and connected to the stator winding within the generator housing and to integrate them in the internal cooling air circulation of the generator.

Finally, it was previously proposed in conjunction with a small generator used to generate welding current to locate the diode bridges of the static excitation means on cylindrical cooling plates, which are ventilated by the air flow of fans mounted on the generator (see EP-A1-0 329 368).

### BRIEF DESCRIPTION OF THE INVENTION

The object of the present invention is to provide an air-cooled generator with static excitation means that is distinguished by its simple, space-saving design and enhanced operational reliability.

The object is achieved by means of all the features set forth in claim 1. The heart of the invention is seen in locating the cooled rectifier bridge arrangement within a cooling air circuit of the generator. Integrating the rectifier bridge arrangement within the generator and its internal cooling air circuit is advantageous in that it eliminates the need for special cool air ventilation for the rectifier bridge, in that the rectifier disposed in a closed cooling air circuit within the generator is protected from contamination or corrosion from chemical impurities carried by external cooling air, as is the case, for example, with conventional cabinet-type rectifiers, and in that the source of cooling medium is the fan in the self-ventilated generator itself, which it seen as a very reliable unit as compared to a fan in an external rectifier cabinet.

In a preferred and particularly space-saving embodiment of the present invention the generator is encased in a generator housing, and the cooled rectifier bridge arrangement is located within the interior of the generator housing and is ventilated by cool air via the cooling air circuit.

According to a second embodiment of the present invention, planning and assembly are facilitated in a generator comprised of a rotor and stator, if slip rings are provided on the rotor, which slip rings are connected to the cooled rectifier bridge arrangement by an excitation line, and where the excitation line is integrated within the generator.

Still a further embodiment of the present invention is characterized in that the cooled rectifier bridge arrangement is connected by an excitation transformer to a bus bar of the generator, and in that said excitation transformer is added as a pre-assembled unit to the generator. This further enhances the compactness of the system.

This also applies to a static excitation means that comprises an electronic control means, and where such control means is located in the vicinity of the generator.

### BRIEF DESCRIPTION OF THE DRAWINGS

Preferred embodiments of the present invention are described in greater detail with reference to the drawings. The single FIGURE is a schematic diagram of a preferred embodiment of a generator with static excitation means according to the present invention.

### WAYS OF IMPLEMENTING THE INVENTION

The figure is a schematic diagram of a preferred embodiment of a generator with static excitation means according to the present invention. The generator 10 comprises a rotor 17 rotatable about an axis 13 and a stator 14 concentrically surrounding said rotor 17, said stator being mounted in the interior 12 of the generator housing 11. The generator 10 has an internal cooling air circuit 23 for purposes of cooling the windings in the rotor 17 and the stator 14. Within the cooling air circuit cool air circulated by fans 15, 16 mounted on the stator 14 absorbs heat from the rotor 17 and the stator 14 and conveys it to an external cooling circuit in a heat exchanger unit 20.

The voltage induced in the stator windings is conveyed outwardly by a generator bar bus 18. An excitation means is provided for generating a magnetic field in the rotor 17, which excitation means comprises a rectifier bridge arrangement 26 (frequency converter). The rectifier bridge arrangement 26 converts alternating current at the input thereof to direct current which is then conveyed via an excitation line 24 and slip rings 25 to excitation coils disposed in the stator 17. The amount of alternating current required at the input of the rectifier bridge arrangement 26 is either supplied externally (during start-up) by an external excitation line 21 or (during operation) is drawn from an excitation transformer 19 on the generator bus bar 18. Excitation is controlled and regulated by an electronic control means 22 that is coupled to the rectifier bridge arrangement 26.

For purposes of cooling, the rectifier bridge arrangement 26 is disposed within the internal cooling air circuit 23 of the generator 10. The excitation transformer 19 is added as a pre-assembled unit to the generator. The excitation line 24 is integrated in the generator 10. The electronic control means 22 is located in the vicinity of the generator 10. In addition, it is feasible to incorporate a de-energizing means along the excitation line 24 at the generator 10.

The aforementioned generator configuration has the following characteristics and advantages:

A special cooling ventilation for the rectifier bridge arrangement (frequency converter) is not needed.

In generators with closed cooling ventilation, rectifiers are also disposed within the closed cooling air circuit; thus, they are protected from contamination or corrosion by chemical impurities carried by external cooling air, as is the case with conventional cabinet-type rectifiers. This advantage is eliminated by definition in generators with open cooling air circulation.

Fans required in conventional excitation means have been shown to have a low MTBF, and therefore multiple fan installations are often required. In the present invention the source of cooling medium is the fan in the self-ventilated generator itself, which is by definition a very reliable unit.

Planning and assembly are facilitated if connecting lines between the rectifier and the slip rings are permanently integrated in the generator.

The load limits of generator and rectifier are dependent in the same way upon the temperature of the cooling means, hence, identical cooling temperature results in a clear correspondence in the characteristic curve of these values.

### List of Reference Numerals

10 generator

11 generator housing

12 interior (generator housing)

13 axis

14 stator

15,16 fan

17 rotor

18 generator bus bar

19 excitation transformer

20 heat exchanger

21 external excitation line

22 electronic control

23 cooling air circuit

24 excitation line

25 slip ring

26 rectifier bridge arrangement

We claim:

1. An air-cooled high power generator comprising:
a cooling air circuit; and
a static excitation means comprising a cooled rectifier bridge arrangement disposed in the cooling air circuit.

2. A generator according to claim 1, wherein the generator comprises and is encased by a generator housing having an interior; and
wherein the cooled rectifier bridge arrangement is disposed in the interior of the generator housing and is arranged to be ventilated by cool air from the cooling air circuit.

3. A generator according to claim 2, further comprising:
a rotor;
a stator;
an excitation line; and
slip rings mounted on the rotor and linked to the cooled rectifier bridge arrangement by the excitation line;
wherein the excitation line is integrated in the generator.

4. A generator according to claim 1, further comprising:
an excitation transformer; and
a generator bus bar;
wherein the cooled rectifier bridge arrangement is connected by the excitation transformer to the generator bus bar of the generator; and
wherein the excitation transformer is added as a pre-assembled unit to the generator.

5. A generator according to claim 1, wherein the static excitation means comprises an electronic control means, and wherein said electronic control means is located in the vicinity of the generator.
